(19) United States
(12) Patent Application Publication
(10) Pub. No.: US 2008/0151597 A1
(43) Pub. Date: Jun. 26, 2008

(54) Wear-resistant multilayer probe

(75) Inventors: James Dillon Kiely, Sewickley, PA (US); Corina Nistorica, San Jose, CA (US); Yiao-Tee Hsia, Pleasanton, CA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/642,093

(22) Filed: Dec. 20, 2006

(51) Int. Cl. G01D 21/00

(52) U.S. Cl. 365/145; 73/866.5

(57) ABSTRACT

A data storage device includes a probe having a first conductive element, a second conductive element and an insulator layer positioned between the first conductive element and the second conductive element.

### FIELD OF THE INVENTION

The invention relates generally to data storage devices and, more particularly, to an improved data storage device having a more wear resistant probe for such devices.

### BACKGROUND INFORMATION

Data storage devices, such as probe storage devices, are being proposed to provide small size, high capacity, low cost data storage devices. Such probe storage devices may include one or more probes, that each includes a conductive element (e.g., an electrode), which are positioned adjacent to and in contact with a ferroelectric thin film media. Binary “1's” and “0's” are stored in the media by causing the polarization of the ferroelectric film to point “up” or “down” in a spatially small region (domain) local to a tip of the probe by applying suitable voltages to the probe through the conductive element. Data can then be read by a variety of techniques, including sensing of piezoelectric surface displacement, measurement of local conductivity changes, or by sensing current flow during polarization reversal (destructive readout). Regardless of the type of readback mechanism, the probes should be mechanically robust and include an area of hard insulator around or adjacent to the conductive element to provide wear resistance.

Probe ferroelectric media typically includes a protective overcoat to minimize wear and limit contamination of the media. The probe may also include a protective overcoat to minimize wear of the probe. The probe and media protective overcoat thicknesses along with lubricant film thickness applied to the media protective overcoat combine to contribute to a large portion of the total head-to-media spacing budget. This spacing in turn affects the writing voltage efficiency, the readback efficiency, and the physical dimensions of the data written to the ferroelectric media. Thus, eliminating or reducing the need for the protective overcoats may improve the efficiencies and dimensions of the probe storage system.

Accordingly, there is identified a need for improved data storage devices that overcome limitations, disadvantages and shortcomings of known data storage devices.

### SUMMARY OF THE INVENTION

The invention meets the identified need, as well as other needs, as will be more fully understood following a review of this specification and drawings.

An aspect of the present invention is to provide an apparatus including a probe including a first conductive element, a second conductive element and an insulator layer positioned between the first conductive element and the second conductive element. The apparatus may further include a third conductive element and an additional insulator layer positioned between the second conductive element and the third conductive element. The first conductive element and/or the second conductive element may each have a width in the range of about 2 nm to about 50 nm. The insulator layer may also have a width in the range of about 2 nm to about 50 nm.

Another aspect of the present invention is to provide an apparatus including a ferroelectric storage media and a probe adjacent the media wherein the probe includes a first conductive element, a second conductive element and an insulator layer positioned between the first conductive element and the second conductive element. The apparatus may further include a third conductive element and an additional insulator layer positioned between the second conductive element and the third conductive element. The first conductive element and/or the second conductive element may each have a width in the range of about 2 nm to about 50 nm. The insulator layer may also have a width in the range of about 2 nm to about 50 nm.

A further aspect of the present invention is to provide an apparatus including a probe having a tip portion, said tip portion including a first conductive element, a second conductive element and an insulator layer positioned between the first conductive element and the second conductive element. The tip portion may further include a third conductive element and an additional insulator layer positioned between the second conductive element and the third conductive element. The first conductive element and/or the second conductive element may each have a width in the range of about 2 nm to about 50 nm. The insulator layer may also have a width in the range of about 2 nm to about 50 nm.

### BRIEF DESCRIPTION OF THE DRAWINGS

FIG. 1 is a schematic cross-sectional view of an embodiment of a data storage device constructed in accordance with the invention.

FIG. 2 is a detailed side view of an embodiment of a ferroelectric storage media that can be used in accordance with the invention.

FIG. 3 is a schematic side view of an embodiment of a single probe constructed in accordance with the invention.

FIG. 4 is a schematic side view of an additional embodiment of a single probe constructed in accordance with the invention.

### DETAILED DESCRIPTION

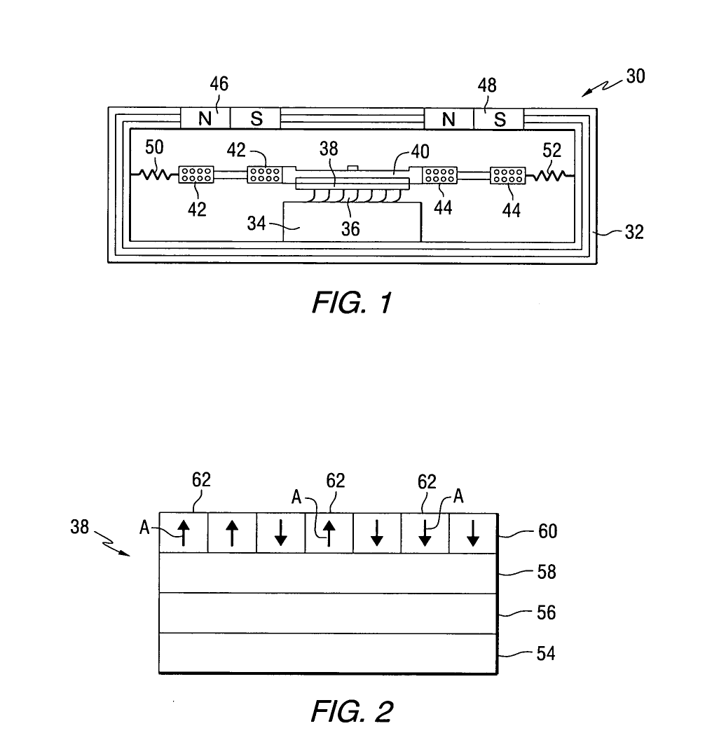

FIG. 1 is a schematic cross-sectional view of an embodiment of a data storage device 30 constructed in accordance with the invention. The device 30 includes an enclosure 32 (which also may be referred to as a case, base, or frame) that contains a substrate 34. An array of probes 36 is positioned on the substrate 34. The probes 36 extend upward to make contact with a ferroelectric storage media 38. The storage media 38 is mounted on a movable member 40 (which also may be referred to as a sled). Coils 42 and 44 are mounted on the movable member 40. Magnets 46 and 48 are mounted in the enclosure 32 near the coils 42 and 44, respectively. Springs 50 and 52 form part of a suspension assembly that supports the movable member 40. It will be appreciated that the combination of coils 42 and 44 and magnets 46 and 48 forms an actuator assembly that is used to move the movable member 40. Electric current in the coils 42 and 44 creates a magnetic field that interacts with the magnetic field produced by the magnets 46 and 48 to produce a force that has a component in the plane of the movable member 40 and causes linear movement of the movable member 40. This movement in turn causes individual storage locations or domains on the media 38 to be moved relative to the probes 36.

While FIG. 1 shows one embodiment of a data storage device 30, the invention is not limited to any particular configuration of data storage device or associated components. For example, the probes 36 can be arranged in various configurations relative to the media 38, or the probes 36 could be positioned above the media 38. In addition, other types of actuator assemblies, such as, for example, electrostatic actuators, can provide the relative movement between the probes 36 and the media 38.

FIG. 2 is a more detailed side view of an embodiment of the ferroelectric storage media 38 that can be used in accordance with the invention. In this embodiment, the storage media 38 includes a substrate 54, which can be for example Si, an intermediate or seed layer 56, which can be for example SrTiO₃, positioned adjacent to the substrate 54, an additional intermediate or seed layer 58, which can be for example SrRuO₃, positioned adjacent to the layer 56, and a ferroelectric storage layer 60, which can be for example lead zirconium titanate (PZT), positioned adjacent to the layer 58. However, it will be appreciated that other intermediate or seed layers may be used between the substrate 54 and the storage layer 60. While specific example materials are described herein, it should be understood that this invention is not limited to the example materials.

Still referring to FIG. 2, the ferroelectric storage layer 60 includes a plurality of individual domains 62 that have designated polarizations, as indicated by arrows A, that represent the data being stored in each domain 62.

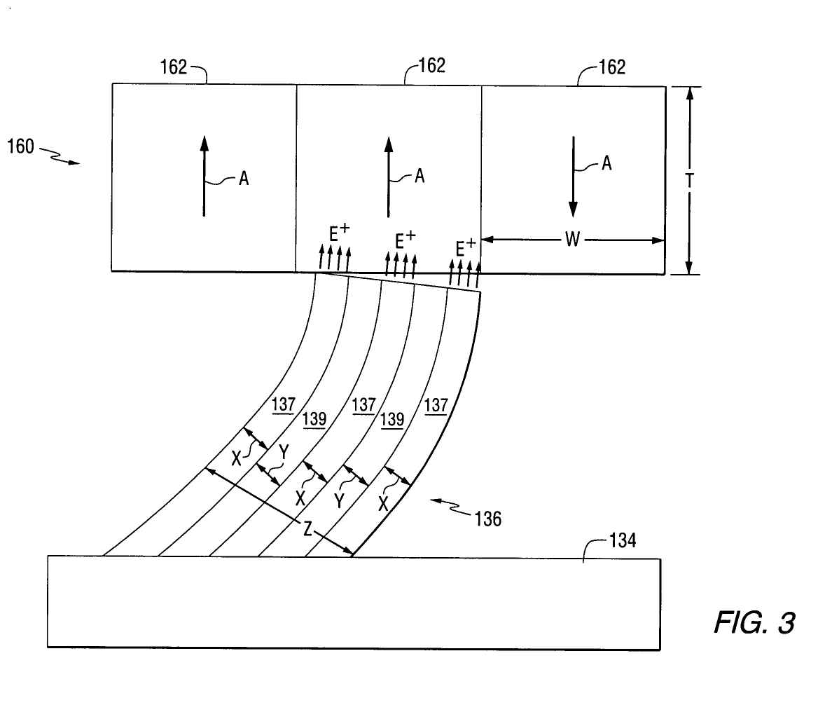

FIG. 3 is a schematic side view of an embodiment of a single probe 136 constructed in accordance with the invention. The probe 136 is positioned on a substrate 134 and extends upward to make contact with a storage layer 160 of a ferroelectric storage media in order to write data to the storage layer 160. It will be appreciated that the single probe 136 is shown for simple illustration, but that a plurality of probes 136 may be provided to construct a data storage device to store data in the polarizable ferroelectric domains 162 of a ferroelectric storage media.

Still referring to FIG. 3, the probe 136 includes conductive elements 137 that are spaced apart and electrically isolated from each other by insulator layers 139. The conductive elements 137 provide for a suitable voltage to pass through the probe 136 so as to collectively apply an electric field E+ to the storage layer 160 to switch the polarization of a particular domain 162. The probe structure of the present invention may be constructed to have two conductive elements 137 with an insulating layer 139 therebetween, or may be constructed to have the structure of conductor/insulator/conductor/insulator/conductor etc. repeated as many times as desired or necessary in order to provide the probe 136 with an overall width Z (see FIG. 3) in the range of about 20 nm to about 1000 nm.

The conductive elements 137 may be formed as a layer of conductive material(s) including, for example, metals (including Cu, Al, Ag, W, Ni, Ti, Ta, Pd, Pt, Ru, Cr, Mo, Ir), alloys of these and other metals, intermetallic alloys, metallic carbides (including SiC and TiC), conductive nitrides (including TiN, ZrN, VN CrN, and TiAlN), borides, conductive oxides (including RuO₂, ReO₂, and CrO₂), silicides, conducting ceramics, or carbon-based materials. Each conductive element 137 may have a width X (see FIG. 3) in the range of about 2 nm to about 50 nm.

The insulator layers 37 may be formed of any suitable insulating material(s) including for example, oxides (including Al₂O₃, SiO₂, Cr₂O₃, ZrO₂, TiO₂, HfO₂, BeO, MgO), insulating nitrides (including Si₃N₄, BN, C₃N₄), or diamond and diamond-like materials. Each insulator layer 139 may have a width Y (see FIG. 3) in the range of about 2 nm to about 50 nm.

The probe 136 may be constructed using conventional sputtering and deposition techniques to form the multilayered structure conductor/insulator/conductor/insulator/conductor etc.

As a result of passing a voltage through each conductive element 137, an electric field is applied by each conductive element 137 to the domain 162 adjacent to the probe 136. The electric field from each conductive element 137 overlaps with the electric field from the adjacent conductive element(s) to give a combined electric field E+ from all of the conductive elements 137 that cumulatively provides sufficient field strength to alter the polarization of the particular domain 162.

As shown in FIG. 3, each domain 162 is formed to have a width W in the range of about 20 nm to about 1000 nm. The width W is determined by the width of the field applied by the probe 136.

As shown in FIG. 3, the storage layer 160 has a thickness T in the range of about 5 nm to about 100 nm. The width X of each conductive element 137 is designed in conjunction with the thickness T of the storage layer 160 such that the width X is smaller than the thickness T. If the conductive element 137 width X is larger than the thickness T, the resultant electric field E+ from the conductive elements 137 could result in multiple separated written domains. When the conductive element 137 width X is smaller than the storage layer thickness T, the resultant field E⁺ from the conductive elements 137 overlaps such that a single domain is written that is approximately equal to the probe 136 width Z. It will be appreciated that various configurations of the probe 136 dimensions, including the conductive element 137 and insulator layer 139 dimensions, relative to the dimensions of the storage layer 160 may be developed in accordance with the invention.

Due to the contact between the probe 136 and storage layer 160, the probe 136 needs to be wear resistant. The insulator layers 139 contribute to the overall hardness of the probe 136 and make the probe 136 more wear resistant. In addition, the laminated or multilayered structure of the probe 136 and the dimensions selected for the conductive elements 137 and the insulator layers 139 contribute to making the probe 136 more wear resistant.

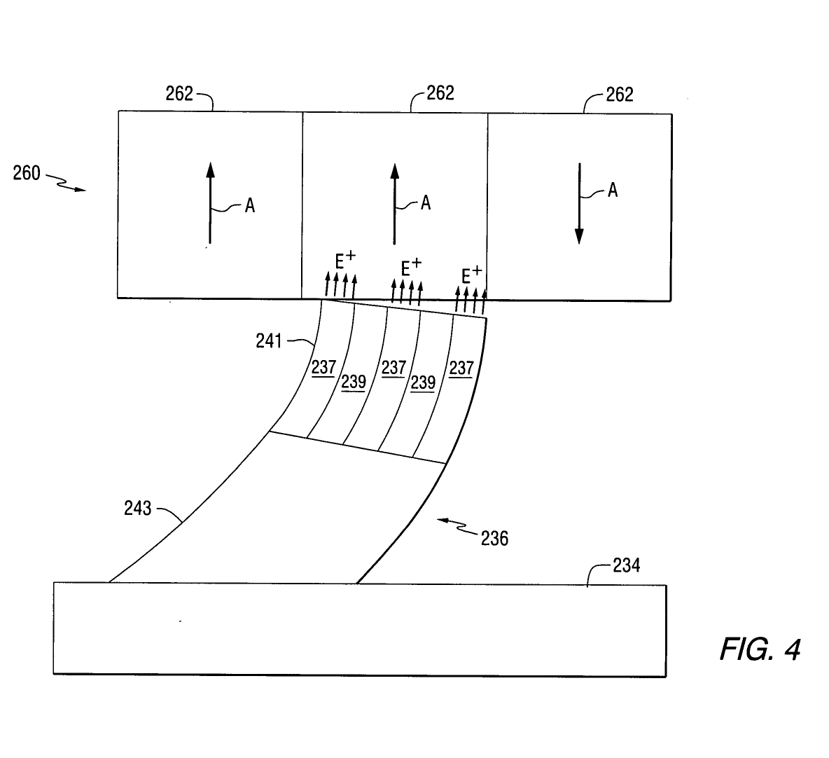

FIG. 4 is a schematic side view of an additional embodiment of a single probe 236 constructed in accordance with the invention. The probe 236 is positioned on a substrate 234 and extends upward to make contact with a storage layer 260 of a ferroelectric storage media. It will be appreciated that the single probe 236 is shown for simple illustration, but that a plurality of probes 236 may be provided to construct a data storage device to store data in polarizable ferroelectric domains 262.

Still referring to FIG. 4, the probe 236 includes a tip portion 241 adjacent to the storage layer 260 and a base portion 243 adjacent to the substrate 234. The tip 241 includes conductive elements 237 that are spaced apart and electrically isolated from each other by insulator layers 239. The conductive elements 237 provide for a suitable voltage to pass through the probe tip 241 so as to collectively apply an electric field E+ to the storage layer 260 to switch the polarization of a particular domain 262. The probe tip structure of the present invention may be constructed to have two conductive elements 237 with an insulating layer 239 therebetween, or may be constructed to have the structure of conductor/insulator/conductor/insulator/conductor etc. repeated as many times as desired or necessary in order to provide the probe 236 of desired width.

The base 243 of the probe 236 may be formed through deposition processes such as, for example, sputter deposition. The base 243 of the probe 236 can be designed to enhance other performance characteristics, such as bending angle or stiffness, while only the tip 241 is optimized for electric field delivery and high wear resistance. The base 243 can include conducting and insulating materials such that the conducting material acts as an electrode structured and arranged for conducting a voltage to the conductive elements 237.

Whereas particular embodiments have been described herein for the purpose of illustrating the invention and not for the purpose of limiting the same, it will be appreciated by those of ordinary skill in the art that numerous variations of the details, materials, and arrangement of parts may be made within the principle and scope of the invention without departing from the invention as described in the appended claims. In addition, it will be appreciated that the invention described herein has utility in various technologies such as, for example, data storage, scanning probe microscopy, probe based biological or electrochemical analysis, nanolithography, or electrical metrology.

What is claimed is:

1. An apparatus, comprising:
a probe including a first conductive element, a second conductive element and an insulator layer positioned between said first conductive element and said second conductive element.

2. The apparatus of claim 1, further comprising a third conductive element and an additional insulator layer positioned between said second conductive element and said third conductive element.

3. The apparatus of claim 1, wherein said first conductive element and said second conductive element are each formed of Cu, Al, Ag, W, Ni, Ti, Ta, Pd, Pt, Ru, Cr, Mo, Ir, SiC, TiC, TiN, ZrN, VN, CrN, TiAlN, RuO₂, ReO₂, or CrO₂.

4. The apparatus of claim 1, wherein said first conductive element and said second conductive element each have a width in the range of about 2 nm to about 50 nm.

5. The apparatus of claim 1, wherein said insulator layer is formed of Al₂O₃, SiO₂, Cr₂O₃, ZrO₂, TiO₂, HfO₂, MgO, Si₃N₄, BN or C₃N₄.

6. The apparatus of claim 1, wherein said insulator layer has a width in the range of about 2 nm to about 50 nm.

7. The apparatus of claim 1, wherein said probe has a width in the range of about 20 nm to about 1000 mm.

8. An apparatus, comprising;
a ferroelectric storage media; and
a probe positioned adjacent said ferroelectric storage media, said probe including a first conductive element, a second conductive element and an insulator layer positioned between said first conductive element and said second conductive element.

9. The apparatus of claim 8, wherein said ferroelectric storage media includes a storage layer, said storage layer having a thickness in the range of about 5 nm to about 100 nm.

10. The apparatus of claim 9, wherein said storage layer has a plurality of individually polarizable domains, said domains each having a width in the range of about 20 nm to about 1000 nm.

11. The apparatus of claim 8, wherein said probe has a width in the range of about 20 nm to about 1000 nm.

12. The apparatus of claim 8, wherein said first conductive element and said second conductive element each have a width in the range of about 2 nm to about 50 nm.

13. The apparatus of claim 8, wherein said insulator layer has a width in the range of about 2 nm to about 50 nm.

14. An apparatus, comprising:
a probe having a tip portion, said tip portion including a first conductive element, a second conductive element and an insulator layer positioned between said first conductive element and said second conductive element.

15. The apparatus of claim 14, wherein said tip portion further comprises a third conductive element and an additional insulator layer positioned between said second conductive element and said third conductive element.

16. The apparatus of claim 14, wherein said first conductive element and said second conductive element are each formed of Cu, Al, Ag, W, Ni, Ti, Ta, Pd, Pt, Ru, Cr, Mo, Ir, SiC, TiC, TiN, ZrN, VN, CrN, TiAlN, RuO₂, ReO₂, or CrO₂.

17. The apparatus of claim 14, wherein said first conductive element and said second conductive element each have a width in the range of about 2 nm to about 50 nm.

18. The apparatus of claim 14, wherein said insulator layer is formed of Al₂O₃, SiO₂, Cr₂O₃, ZrO₂, TiO₂, HfO₂, MgO, Si₃N₄, BN or C₃N₄.

19. The apparatus of claim 14, wherein said insulator layer has a width in the range of about 2 nm to about 50 nm.

20. The apparatus of claim 14, wherein said probe has a width in the range of about 20 nm to about 1000 nm.
